(19) United States
(12) Patent Application Publication
(10) Pub. No.: US 2015/0260900 A1
(43) Pub. Date: Sep. 17, 2015

(54) ELECTRONIC DEVICE

(71) Applicant: Panasonic Intellectual Property Management Co., Ltd., Osaka (JP)

(72) Inventors: Suguru NAKAO, Hyogo (JP); Shuji YAMASHITA, Nara (JP); Hiromi KANZAWA, Osaka (JP); Naoto TADA, Kanagawa (JP)

(21) Appl. No.: 14/727,735

(22) Filed: Jun. 1, 2015

Related U.S. Application Data
(63) Continuation of application No. PCT/JP2013/005894, filed on Oct. 3, 2013.

(30) Foreign Application Priority Data
Mar. 21, 2013 (JP) 2013-057626

(51) Int. Cl. F21V 8/00

(52) U.S. Cl. CPC G02B 6/0031; G02B 6/0068

(57) ABSTRACT

An electronic device according to the technology disclosed herein includes a decoration part in which a light-emitting part is exposed at the surface of a housing of the device. The decoration part includes light-guiding part having the light-emitting part, and a plurality of light sources mounted to light-guiding part. Light-guiding part includes light-source mounting surfaces to which light sources are mounted, and first reflection surfaces and second reflection surfaces which both reflect light emitted from light sources.

### TECHNICAL FIELD

The present technology disclosed herein relates to electronic devices such as display devices including thin-type display devices and portable displays, i.e. smartphones, tablets, etc., which each have a housing for decorations at the periphery of its display part.

### BACKGROUND ART

Thin-type display devices and portable displays, such as smartphones and tablets, employ a configuration in which a liquid crystal display device or an organic EL display device is used as a display part thereof, and a housing for decorations covers the periphery of the display part (see Patent Literature 1).

Since the display devices of this type have a simple flat-plate shape, in order to increase their commodity values in design, something new has come to be introduced into the decorations of their housings that cover the peripheries of their display parts.

### CITATION LIST

### Patent Literature

Patent Literature 1: Japanese Patent Unexamined Publication No. 2006-53528

### SUMMARY

The technology disclosed herein is to provide an electronic device which includes a decoration part in which a light-emitting part is exposed at the surface of its housing. The decoration part includes a light-guiding part which has the light-emitting part, and a plurality of light sources mounted to the light-guiding part. The light-guiding part includes light-source mounting surfaces, and first reflection surfaces and second reflection surfaces which both reflect light emitted from the light sources.

### BRIEF DESCRIPTION OF DRAWINGS

FIG. 1 is a perspective view of a display device according to an embodiment of the technology disclosed herein.

FIG. 2 is a plan view illustrating an arrangement structure of the inside of the display device, with a back cover having been removed.

FIG. 3 is an enlarged plan view of portion A of FIG. 2.

FIG. 4 is an enlarged plan view of portion B of FIG. 3.

FIG. 5 is a perspective view illustrating a positional relation between a frame body and a decoration part of a housing.

FIG. 6 is an enlarged perspective view of portion C of FIG. 5.

FIG. 7 is an illustrative view of an enlarged part of a light-guiding part and a light source of the decoration part.

FIG. 8 is an illustrative view of a relation between locations of the light sources of the decoration part and a luminance distribution of light emitted from a light-emitting part.

### DESCRIPTION OF EMBODIMENTS

Hereinafter, an electronic device according to an embodiment of the technology disclosed herein will be described using a display device as an example, with reference to the accompanying drawings. It is noted, however, that descriptions in more detail than necessary will sometimes be omitted. For example, detailed descriptions of well-known items and duplicate descriptions of substantially the same configuration will sometimes be omitted, for the sake of brevity of the following descriptions and easy understanding by those skilled in the art.

Note that the present inventors provide the accompanying drawings and the following descriptions so as to facilitate fully understanding of the technology disclosed herein by those skilled in the art. The inventors in no way intend for these drawings and descriptions to impose any limitation on the subject matter described in the appended claims.

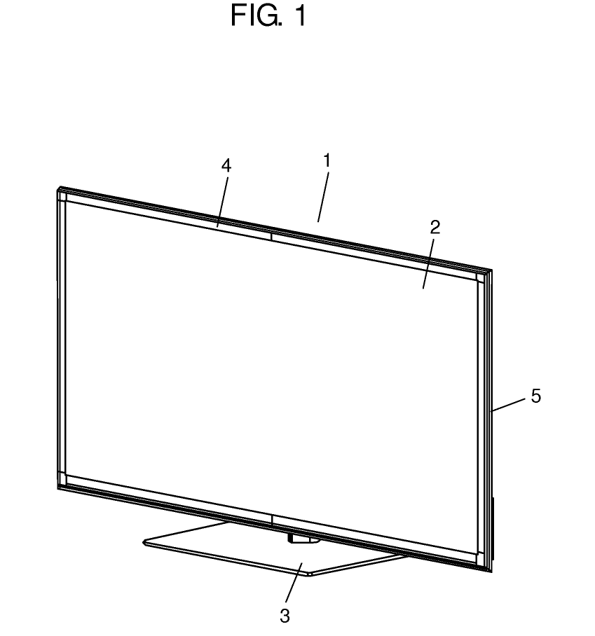

FIG. 1 is a perspective view of the display device according to the embodiment of the technology. As shown in FIG. 1, the thin-type display device is configured such that a display module (not shown) such as a flat-plate liquid crystal display or a flat-plate organic EL display is accommodated in housing 1. On the front side of the display device, display part 2 is disposed which is configured with the display module. Stand 3 is to hold the display device in an installed state.

Moreover, housing 1 is configured with frame body 4 and a back cover (not shown). Frame body 4 is a picture frame-like body made of a metal or a resin, and is disposed at the periphery of display part 2, on the front side of the display module. The back cover is made of a metal or a resin, and is disposed to cover the back side of the display module. At the surface of frame body 4 of housing 1, a light-emitting part serving as a part of decoration part 5 is exposed over the entire circumference of the frame body. Note that, in FIG. 1, the light-emitting part of decoration part 5 is exposed at the surface of housing 1 over the entire circumference; however, the light-emitting part may be configured to be exposed at only a part of the surface, i.e. at one of the upper, lower, left, and right sides of the housing, for example.

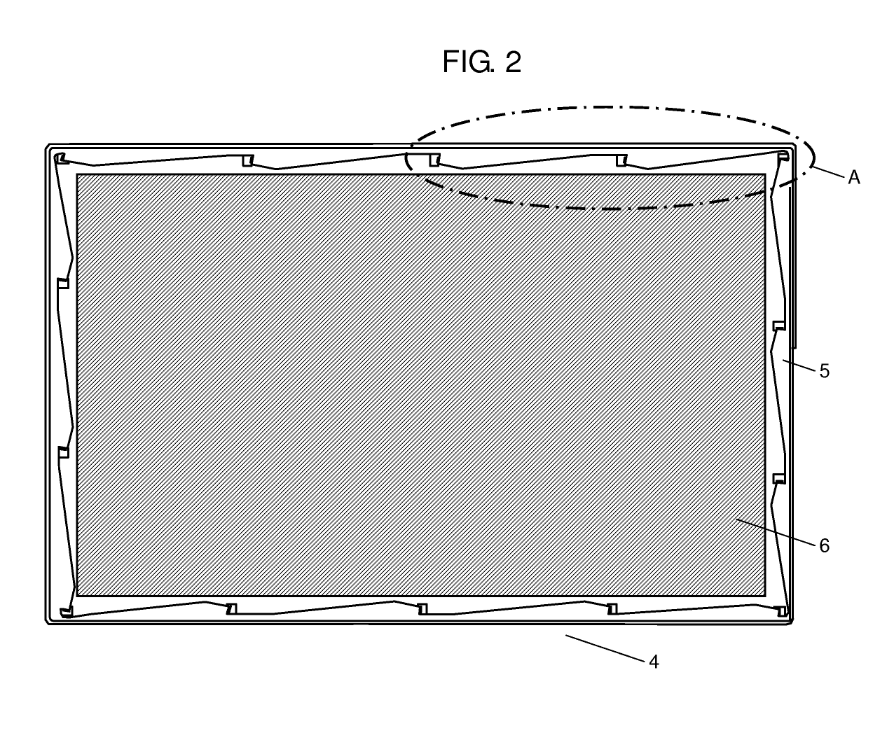

FIG. 2 is a plan view illustrating an arrangement structure of the inside of the display device, with a back cover having been removed. As shown in FIG. 2, display module 6 is disposed in the inside of housing 1. Between display module 6 and frame body 4 of housing 1, decoration part 5 having a picture frame-like shape is disposed.

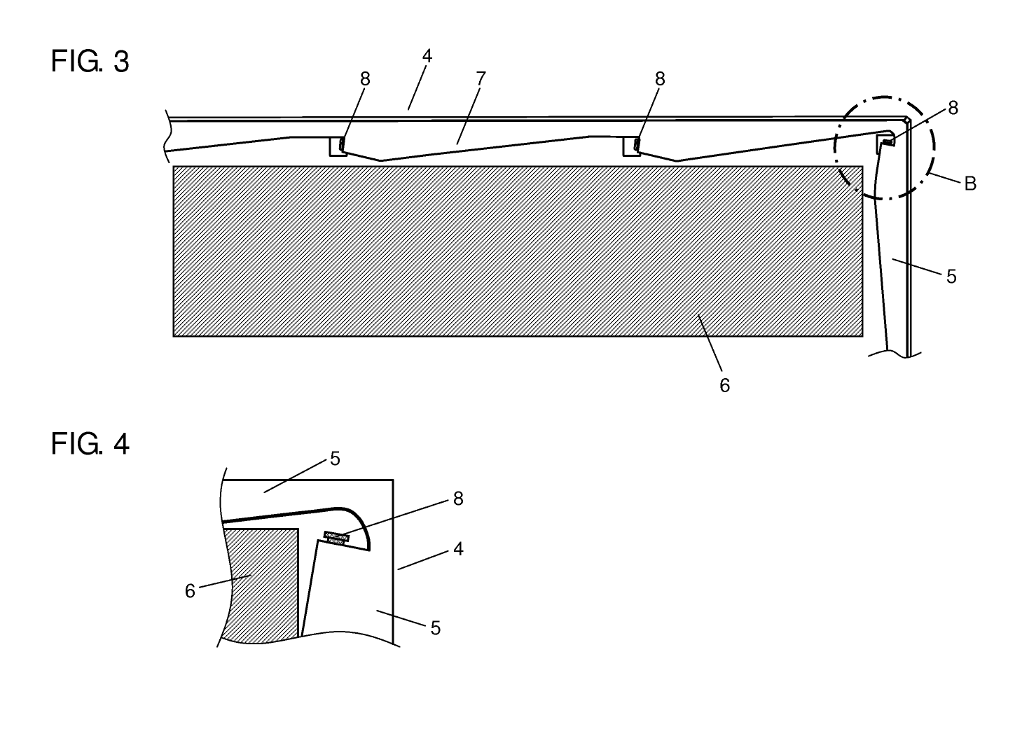

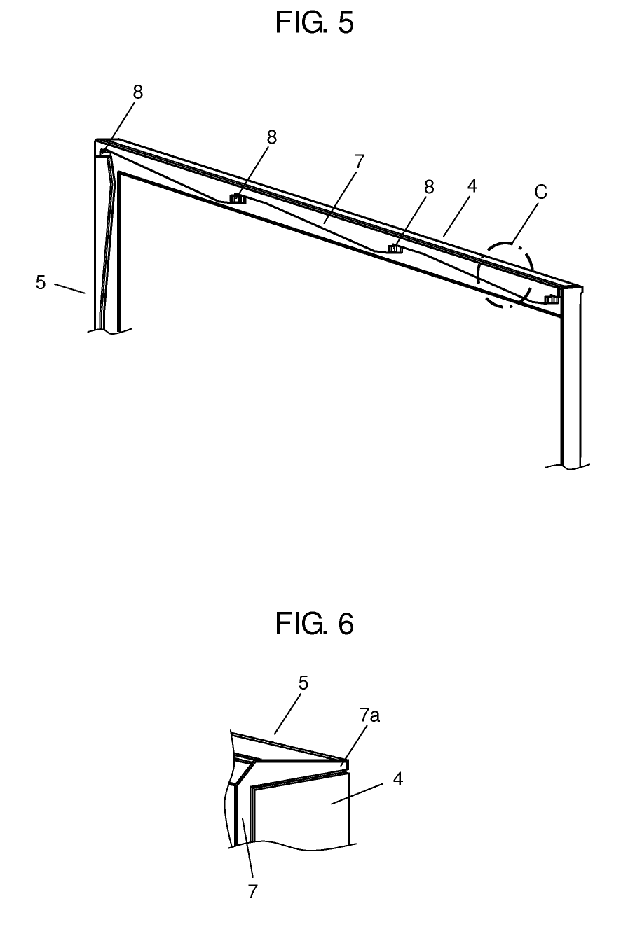

FIG. 3 is an enlarged plan view of portion A of FIG. 2. FIG. 4 is an enlarged plan view of portion B of FIG. 3. Moreover, FIG. 5 is a perspective view illustrating a positional relation between the frame body and the decoration part of the housing. FIG. 6 is an enlarged perspective view of portion C of FIG. 5.

As shown in FIGS. 3 to 5, decoration part 5 includes light-guiding part 7 and a plurality of light sources 8. The light-guiding part is formed with a light-transmissive resin material including an acrylic and a polycarbonate resin. The plurality of the light sources are mounted to light-guiding part 7 at predetermined intervals, each of which is configured with an LED and a lens. Moreover, as shown in FIG. 6, light-guiding part 7 of decoration part 5 includes light-emitting part 7a. Light-emitting part 7a is disposed to be exposed at the surface on the front side of housing 1, over the entire circumference of frame body 4. Light emitted from light sources 8 is guided by light-guiding part 7 to exit from the surface on the front side of frame body 4. That is, lighting-on of light sources 8 of decoration part 5 produces a loop of light on the front side of frame body 4.

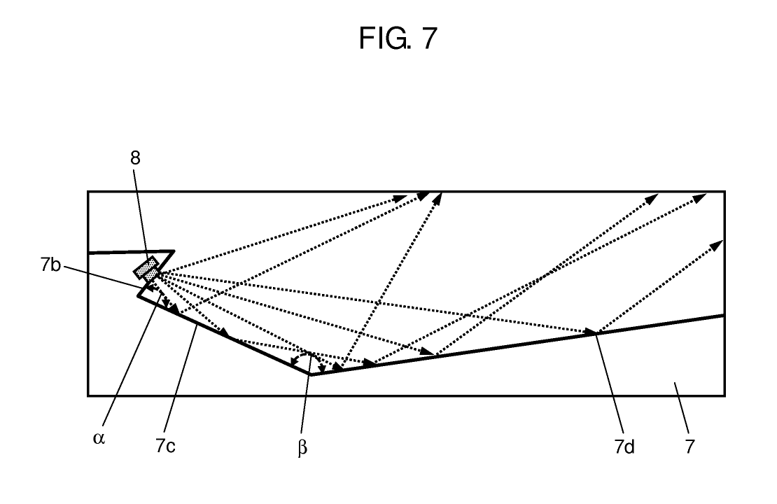

FIG. 7 is an illustrative view of an enlarged part of the light-guiding part and the light source of the decoration part. As shown in FIG. 7, light-guiding part 7 includes light-source mounting surfaces 7b to where light sources 8 are mounted, and first reflection surfaces 7c and second reflection surfaces 7d which both reflect the light emitted from light sources 8. Each of first reflection surfaces 7c is formed such that an angle of “α” relative to light-source mounting surface 7b is α≦90°. Moreover, each of second reflection surfaces 7d is formed to be larger in length than first reflection surface 7c, and formed such that an angle of “β” relative to first reflection surface 7c is an obtuse angle, i.e. β>100°. Here, each of light sources 8 is configured with the LED and the lens which broadens the orientations of the light from the LED and emits the broadened light.

Accordingly, as indicated by the arrows in FIG. 7, the light emitted from one of light sources 8 travels in the following four optical paths. One is the path through which the light is guided directly to light-emitting part 7a. The second is the path through which the light is guided to first reflection surface 7c, and then reflected off first reflection surface 7c to reach light-emitting part 7a. The third is the path through which the light is guided to second reflection surface 7d, and then reflected off second reflection surface 7d to reach light-emitting part 7a. The fourth is the path through which the light is guided to first reflection surface 7c, then reflected off first reflection surface 7c to reach second reflection surface 7d, and then reflected off second reflection surface 7d to reach light-emitting part 7a. This allows one light source 8 to form a line of light having a long length.

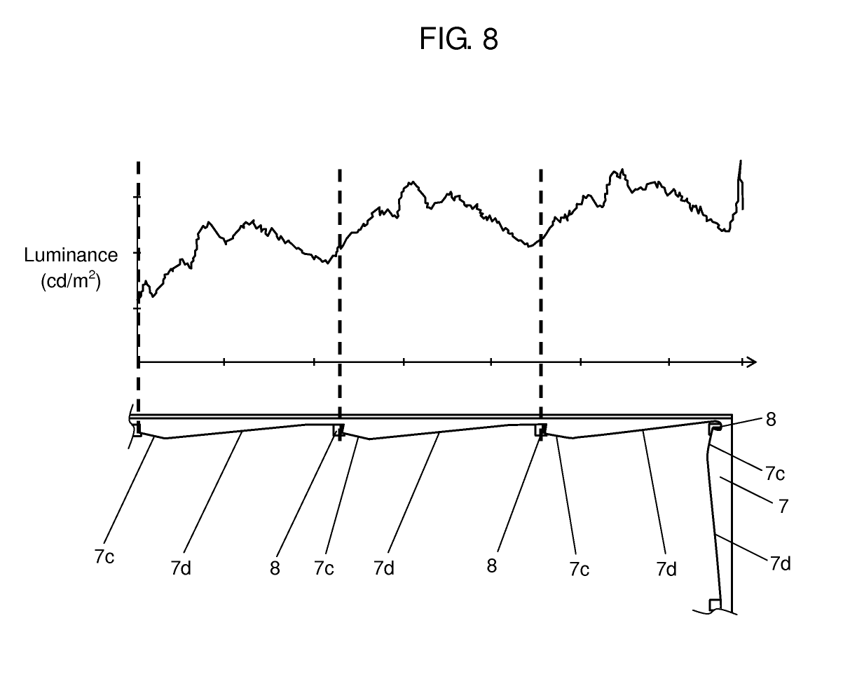

FIG. 8 is an illustrative view of a relation between locations of the light sources of the decoration part and a luminance distribution of the light emitted from the light-emitting part. As shown in FIG. 8, in the luminance distribution of the light emitted from decoration part 5, light sources 8 are disposed at the locations corresponding to valleys in the distribution. Moreover, light-guiding part 7 is configured such that, between specific one of light sources 8 and the next one, there are disposed first reflection surface 7c and second reflection surface 7d. Second reflection surface 7d is larger in length than first reflection surface 7c, and forms an obtuse angle relative to first reflection surface 7c.

It is noted that FIG. 8 shows the positional relation between the luminance distribution at a long side part of the display device and the locations of light sources 8 of decoration part 5; however, the positional relation the same as described above is also held for a short side part of the display device.

Moreover, in the embodiment, the description has been made by exemplifying light-guiding part 7 that includes first reflection surfaces 7c and second reflection surfaces 7d. However, another configuration may also be employed in which another reflection surface may be formed between one of second reflection surfaces 7d and light-source mounting surface 7b located next to the one. In addition, another reflection surface may also be formed between one of first reflection surfaces 7c and second reflection surface 7d located next to the one.

As described above, the technology disclosed herein is to provide the electronic device that includes decoration part 5 in which light-emitting part 7a is exposed at the surface of housing 1. Decoration part 5 includes light-guiding part 7 having light-emitting part 7a, and the plurality of light sources 8 mounted to light-guiding part 7. Light-guiding part 7 includes light-source mounting surfaces 7b to which light sources 8 are mounted, and first reflection surfaces 7c and second reflection surfaces 7d which both reflect the light emitted from light sources 8.

With this configuration, even a small number of light sources 8 are capable of forming the long line of light. On top of that, the line shines with a uniform luminance, providing an advantage of increasing the commodity values in design.

Moreover, in the technology disclosed herein, light sources 8 are disposed at the locations corresponding to the valleys in the distribution of the light emitted from light-emitting part 7a of light-guiding part 7. This configuration allows decoration part 5 to shine with a more uniform luminance, resulting in an increase in the commodity values in design.

As described so far, the embodiments have been described in exemplification of the technology disclosed herein. To this end, the accompanying drawings and the detailed descriptions have been presented.

Consequently, among the constituent elements described in the accompanying drawings and the detailed descriptions, there are possibly included not only essential elements for solving the problems, but also other inessential ones for solving the problems which are used only for the exemplification of the technology described above. For this reason, it should not be acknowledged that these inessential elements are considered to be essential only on the grounds that these inessential elements are described in the accompanying drawings and/or the detailed descriptions.

Moreover, because the aforementioned embodiments are used only for the exemplification of the technology disclosed herein, it is to be understood that various changes and modifications, replacements, additions, omissions, and the like may be made to the embodiments without departing from the scope of the appended claims or the scope of their equivalents.

As described above, the technology disclosed herein is useful in increasing commodity values in design of electronic devices.

What is claimed is:

1. An electronic device having a housing, comprising a decoration part in which a light-emitting part is exposed at a surface of the housing,
wherein the decoration part includes:
a light-guiding part having the light-emitting part, and
a plurality of light sources mounted to the light-guiding part;
the light-guiding part includes:
a light-source mounting surface to which the light sources are mounted,
a first reflection surface to reflect light emitted from the light sources, and
a second reflection surface to reflect the light; and
the light sources are each disposed at a location corresponding to a valley of a luminance distribution of light emitted from the light-emitting part of the light-guiding part.

2. The electronic device according to claim 1,
wherein the first reflection surface of the light-guiding part forms an angle of not larger than 90 degrees relative to the light-source mounting surface, and
the second reflection surface forms an obtuse angle relative to the first reflection surface.

3. The electronic device according to claim 1, wherein the second reflection surface of the light-guiding part is larger in length than the first reflection surface.
